(19) United States
(12) Patent Application Publication
(10) Pub. No.: US 2022/0325676 A1
(43) Pub. Date: Oct. 13, 2022

(54) ONE-PIECE CAST PISTON FOR AN INTERNAL COMBUSTION ENGINE

(71) Applicant: FEDERAL-MOGUL NURNBERG GMBH, NURNBERG (DE)

(72) Inventors: SVEN UNGERMANN, NURNBERG (DE); GEORG HOPP, REDNITZHEMBACH (DE); RAINER WEISS, NURNBERG (DE)

(21) Appl. No.: 17/850,055

(22) Filed: Jun. 27, 2022

Related U.S. Application Data
(63) Continuation of application No. 16/608,535, filed on Oct. 25, 2019.

(30) Foreign Application Priority Data
Apr. 26, 2017 (DE) 102017207005.6

(51) Int. Cl. F02F 3/20; F02F 3/00; F02F 3/26

(52) U.S. Cl. CPC F02F 3/20; F02F 3/0076; F02F 3/0084; F02F 3/26; F02F 2003/0007

(57) ABSTRACT

A one-piece cast piston (10) for an internal combustion engine includes a cooling channel (12) and at least one rib (18) on the inner side of the piston opposite the recess base of a combustion bowl (14).

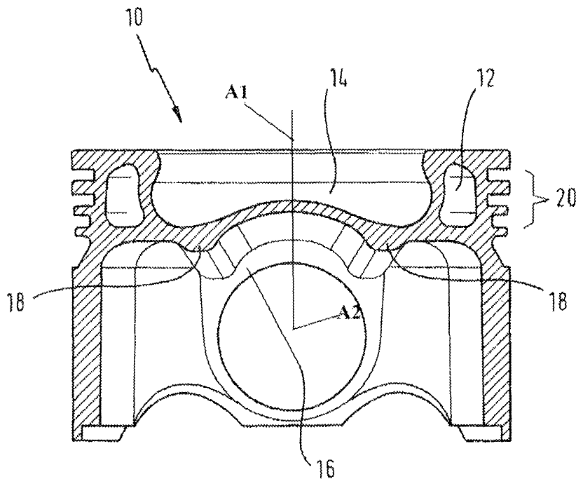

### CROSS-REFERENCE TO RELATED APPLICATION

This U.S. Continuation Patent application claims priority to U.S. Utility application Ser. No. 16/608,535, filed Oct. 25, 2019, which claims priority to International Application No. PCT/EP2018/060487, filed Apr. 24, 2018 which claims priority to German Patent Application No. DE102017207005.6, filed Apr. 26, 2017, the entire contents of which are incorporated herein by reference.

### BACKGROUND

### Technical Field

The invention relates to a one-piece cast piston for an internal combustion engine.

### 2. RELATED ART

It is an essential requirement on pistons for internal combustion engines that they withstand both the temperatures arising and the mechanical stresses. This must also be achieved with a piston of the lowest possible weight.

A two-piece piston for an internal combustion engine is known from DE 101 10 889 C1, one part of which is forged and the other part of which can be cast. A cooling channel is also provided, and on the underside of a combustion bowl, facing the piston underside, a rib is provided. However, the two-piece design of this piston makes it relatively difficult to manufacture. The design freedom is also subject to considerable restrictions due to forging.

DE 10 2013 214 738 A1 concerns a piston cast from aluminium or an aluminium alloy with ribs on the piston underside.

Similar pistons are also disclosed in WO 2006/014741 A2, U.S. Pat. No. 4,428,330 A, and 3,703,126 A.

Against this background, the object of the invention is to create a piston for an internal combustion engine that is an improvement on the above piston and also meets the requirements.

A piston for an internal combustion engine according to the invention is accordingly formed and cast in one piece. It further comprises at least one cooling channel and one rib, which is formed on the piston inner face opposite or, to put it another way, facing away from the recess base of a combustion bowl, in other words on the side of the piston pin bosses. In this regard the recess base is understood to be a “base” of a largely constant thickness which separates the combustion bowl from the piston underside. To form the at least one rib, the base is thicker in areas. In particular, in contrast to the disclosure of the above DE 10 2013 214 738 A1 the thickening of the base can be seen in a cross-section, whereas in the case of the piston according to the above reference the piston crown has on its upper side the combustion bowl formed therein and the piston underside has the ribs, without these contours being related in the manner according to the invention. In further contrast to the above reference, the cooling channel extends in the direction of the piston axis substantially across all annular grooves and its bottom edge lies in the direction of the piston axis preferably at least substantially on the same level as the lower groove edge of the lowest annular groove and/or the deepest point of the combustion bowl.

The one-piece form allows the piston to be manufactured efficiently, and manufacturing by casting opens up many different design possibilities. In particular, the following rib described in more detail below, for example, can be designed in a form that cannot be manufactured through forging or, for instance due to high wear in the forging die, cannot be manufactured economically.

The rib formed according to the invention on the underside of the piston, that is on that side of the recess base of a combustion bowl which faces away from the combustion chamber, both strengthens and stiffens this mechanically highly stressed area and thereby improves the strength properties of the piston overall. Furthermore, the at least one rib has an advantageous effect in respect of the dissipation of the heat arising such that the heat-conducting cross-section is enlarged and the temperature can thus be reduced also in the thermally highly stressed area of the piston. Thus the piston according to the invention meets the requirements particularly well and can also be manufactured efficiently. In particular, the rib can already be brought into the final form by casting by means of corresponding moulds, so that finishing is advantageously unnecessary. It should also be added that the piston according to the invention is preferably used for a diesel engine.

The effect according to the invention can be reinforced by at least one rib extending in the direction of an area of a piston pin boss which is essentially at the maximum distance from the piston axis. IN other words, if the piston is viewed in the direction of the piston pin axis, and the piston crown with combustion bowl is located at the top, at least rib extends to a left or right area of the piston pin boss, preferably two ribs in the direction of the above two areas.

There are advantages particularly in respect of the dissipation of heat in the direction of the piston pin bosses and also in respect of the mechanical stability if at least one rib extends essentially in the direction of the axis of the piston pin bosses. Thus a dissipation of heat in the direction of the piston pin bosses formed with comparatively large cross-sections and hence ultimately a good discharge of heat from the piston overall can be achieved.

This effect can be increased by, as preferred, at least one rib extending in the direction of an area of a piston pin boss which is substantially at the maximum distance from the piston axis. In other words, if the piston is viewed in the direction of the piston pin axis, and the piston crown with combustion bowl is located at the top, at least one rib extends to a left or right area of the piston pin boss, preferably two ribs extend in the direction of the above two areas.

The piston according to the invention is preferably made from an iron material, steel or cast iron. These materials allow the possibility of realising particularly thin wall thicknesses due to their comparatively high strength, and hence of saving weight in an advantageous manner. According to the invention, the lower thermal conductivity inherent in such materials compared with other materials is compensated by the heat dissipation effect described above of the at least one rib.

Although the piston according to the invention can in a known manner have one or more coolant inflows and outflows, the heat dissipation achieved allows the continuous exchange of coolant in the cooling channel to be dispensed with. In other words, coolant inflows and outflows can be avoided, as can measures to fill the cooling channel, such as coolant nozzles. The cooling channel of the piston according to the invention can thus be closed and filled with coolant, yet a sufficiently low temperature can still be guaranteed due to the heat dissipation effect of the at least one rib.

### BRIEF DESCRIPTION OF THE DRAWINGS

The invention is explained in more detail below using a preferred exemplary embodiment.

The figure shows a section of a piston according to the invention which is perpendicular to the piston pin axis.

### DETAILED DESCRIPTION

As can be seen in the figure, the piston 10 according to the disclosed embodiment has in its upper aea, in the piston axis A1 direction at approximately the same level on the outer face, a ring zone 20 located radially within a preferable closed cooling channel 12 and in the central area a combustion bowl 14. Facing away from the recess base, in a section perpendicular to the piston pin axis A2 in the example shown, there is formed at approximately the deepest part of a ω-shaped combustion bowl a thickening or rib 18 on that side of the recess base which is facing away from the combustion chamber, in other words facing towards the piston pin boss 16. In the example shown, two substantially symmetrical ribs are formed which extend essentially parallel to the piston pin axis A2, that is perpendicular to the drawing plane, towards the side areas of the piston pin boss 16. As can be seen in the figure, the ribs 18 are executed in rounded form on their upper side, which is the underside in the orientation shown. This applies equally for the adjacent areas of the piston underside, so that the respective rib 18, when viewed from the outside to the inside, substantially constitutes a succession of a concave, a convex and a concave curve, which in the example shown transitions into the concave curve of the underside of the combustion bowl 14. It should be mentioned that the described form of the rib 18 can be formed in an advantageous manner when the piston is cast, so that no finishing is required.

Obviously, many modifications and variations of the present invention are possible in light of the above teachings. It is, therefore, to be understood that the invention may be practiced otherwise than as specifically described while still being within the scope of the invention.

What is claimed is:

1. A one-piece cast piston for an internal combustion engine, comprising a piston body fabricated of a one-piece casting of iron-based material and including, as part of the one-piece casting, a cooling channel, a pair of pin bosses, and at least one rib on the inner side of the piston opposite a recess base of a combustion bowl, wherein when the piston is viewed in the direction of an axis of the pin bosses, the at least one rib extends from an area of at least one of piston pin bosses which is located at a maximum distance from a piston axis, the piston axis is perpendicular to the piston pin axis, and wherein a lowermost limiting of the cooling channel in a direction of the piston axis is located at essentially the same level as a lower groove flank of a lowest piston-ring groove and/or a deepest point of the combustion bowl.

2. The one-piece cast piston for an internal combustion engine according to claim 1, wherein at least one rib extends in a direction of the axis of the pin bosses.

3. The one-piece cast piston for an internal combustion engine according to claim 1, wherein the cooling channel extends in a direction of the piston axis substantially over the whole area of piston-ring grooves.
